(19) United States
(12) Patent Application Publication
(10) Pub. No.: US 2020/0283575 A1
(43) Pub. Date: Sep. 10, 2020

(54) SILICONE-MODIFIED POLYPHENYLENE ETHER RESIN, PREPARATION METHOD THEREFOR, AND USE THEREOF

(71) Applicant: Shengyi Technology Co., Ltd., Guandong (CN)

(72) Inventors: Chane YUAN, Guangdong (CN); Hongyun LUO, Guangdong (CN); Wei LIN, Guangdong (CN); Huayong FAN, Guangdong (CN)

(73) Assignee: Shengyi Technology Co., Ltd., Guandong (CN)

(21) Appl. No.: 16/066,272

(22) PCT Filed: Sep. 14, 2016
(86) PCT No.: PCT/CN2016/099134

§ 371 Date: Jun. 26, 2018

(30) Foreign Application Priority Data
Dec. 25, 2015 (CN) 201511003854.6

(51) Int. Cl. C08G 65/48; C08L 71/12; C08J 5/24

(52) U.S. Cl. CPC C08G 65/485; C08L 71/126; C08K 3/013; C08J 2371/12; C08J 5/24

(57) ABSTRACT

A silicone-modified polyphenylene ether resin containing an unsaturated double bond, and a thermosetting resin composition, a prepreg, and a laminate containing the resin. By introducing a C═C double bond and a siloxy group into an end group of polyphenylene ether, the resin combines the low dielectric property of double bond curing and the advantages such as desirable heat resistance, weatherability, flame retardancy, dielectric property, and low water absorbency of the siloxy group. The resin can provide a high-frequency, high-speed copper-clad laminate with excellent dielectric property, humidity resistance, and heat resistance that are required by the high-frequency, high-speed copper-clad laminate.

### TECHNICAL FIELD

The present invention belongs to the technical field of copper clad laminates. The present invention relates to a silicone-modified polyphenylene ether resin, a process for preparing the same and use thereof, and further relates to a silicone-modified polyphenylene ether resin containing unsaturated double bonds, a process for preparing the same and use thereof, as well as a thermosetting resin composition, a prepreg and a laminate containing the same.

### BACKGROUND ART

With the increase in the information and communication traffic in recent years, the demand for high-frequency printed circuit boards has increased. In order to reduce the transmission loss in the high-frequency band, electrical insulating materials with excellent electrical characteristics have become the research focus in the field of copper clad laminates. Meanwhile, printed circuit boards or electronic components using these electrical insulating materials require the materials to have a high heat resistance and a high glass transition temperature in order to be able to deal with high-temperature reflow and high-layer assembly at the time of mounting. In the molecular structure of polyphenylene ether resin there contains a large number of benzene ring structures, and there is no strong polar group, which give the polyphenylene ether resin excellent performances, such as high glass transition temperature, good dimensional stability, small linear expansion coefficient, low water absorption rate, especially excellent low dielectric constant and low dielectric loss. In the high-frequency high-speed field, a cured product of a polyphenylene ether resin having a double-bond structure has become a preferred resin material for substrates of high-frequency printed circuit boards because of its excellent mechanical properties and excellent dielectric properties. It relies on the double bonds of the end group and other resins containing double bonds to prepare a laminate by radical reaction or self-curing, and has the characteristics of high glass transition temperature, high heat resistance, and high resistance to moisture and heat.

Siloxane has excellent heat resistance, weather resistance, flame retardancy, dielectric properties and low water absorption rate. The simultaneous introduction of unsaturated double bonds and siloxy groups in the polyphenylene ether resin will further ensure the heat resistance, dielectric properties and hydrophobicity of the cured resin.

Due to better mechanical properties and excellent dielectric properties, polyphenylene ether resins having an unsaturated double bond structure have increasingly become the preferred resin material for substrates of high frequency printed circuit boards. At present, the process for preparing polyphenylene ether resins having C═C double bond at the chain end involves that, for example, it is known to react a polyphenylene ether resin having a hydroxyl group at the chain end with an alkenyl acyl chloride monomer to produce an alkenyl acid ester-polyphenylene ether compound (SABIC, product MX-9000). As described in CN104072751 A, a polyphenylene ether having a phenolic hydroxyl group at the terminal reacted with a vinylbenzyl halide in the presence of an aqueous solution of an alkali metal hydroxide and a phase transfer catalyst in a solvent comprising an aromatic hydrocarbon and a fatty alcohol. The reactants were washed with an aqueous solution of alkali metal hydroxide and hydrochloric acid successively to obtain a vinylbenzyl-polyphenylene ether compound.

There is a need in the art to develop a polyphenylene ether resin having low dielectric, heat resistance, weather resistance, flame retardancy, dielectric properties, and low water absorption rate.

### DISCLOSURE OF THE INVENTION

As to the problems in the art, the object of the present invention lies in providing a silicone-modified polyphenylene ether resin, a resin composition, a resin varnish, a cured resin, a prepreg, a copper clad laminate, a laminate and a printed circuit board containing the same.

The object of the present invention is achieved by the following technical solutions.

A silicone-modified polyphenylene ether resin, wherein the polyphenylene ether resin has a structure of Formula (I)

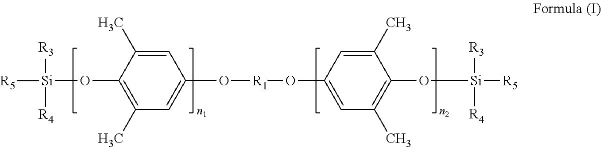

wherein R₁ is selected from the group consisting of

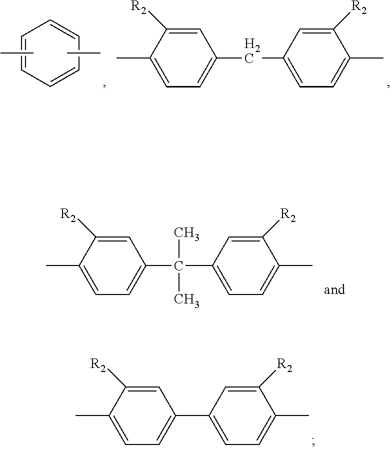

R₂ is selected from the group consisting of H, allyl group and isoallyl group;
R₃, R₄ and R₅ are each independently selected from the group consisting of C₁-C₈ substituted or unsubstituted linear chain or branched chain alkyl group, C₂-C₈ substituted or unsubstituted linear chain or branched chain alkenyl group, C₅-C₁₂ substituted or unsubstituted alicyclic group, C₆-C₂₀ substituted or unsubstituted aryl group and C₆-C₂₀ substituted or unsubstituted aryloxy group, preferably from the group consisting of

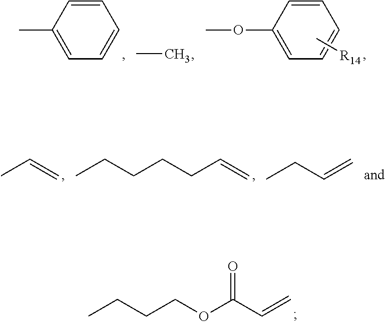

and at least one of R₃, R₄ and R₅ is an unsaturated group; R₁₄ is selected from the group consisting of H, C₁-C₁₄ substituted or unsubstituted linear chain or branched chain alkyl group, C₅-C₁₂ substituted or unsubstituted alicyclic group and C₁-C₁₄ alkoxy group;
n₁ and n₂ are each independently positive integers, and satisfy 4≤n₁+n₂≤25, e.g. n₁+n₂ may be 5, 6, 7, 8, 9, 10, 11, 12, 13, 14, 15, 16, 17, 18, 19, 20, 21, 22, 23, or 24;
preferably, n₁ and n₂ satisfy 6≤n₁+n₂≤20, preferably 8≤n₁+n₂≤15;
preferably, the polyphenylene ether resin is selected from the group consisting of

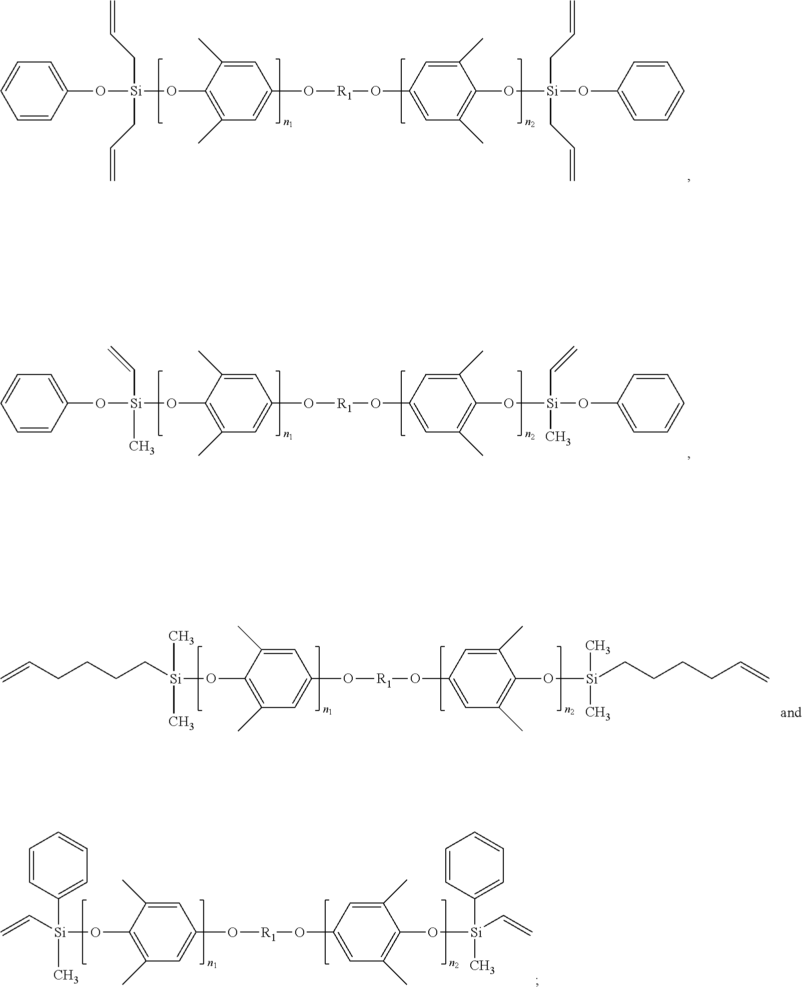

each of n₁ and n₂ in the compounds is independently a positive integer; 4≤n₁+n₂≤25, preferably 6≤n₁+n₂≤20, further preferably 8≤n₁+n₂≤15.

The present invention also provides a process for preparing the polyphenylene ether resin. When R₃ and R₄ are each independently selected from the group consisting of C₁-C₈ substituted or unsubstituted linear chain or branched chain alkyl group, C₂-C₈ substituted or unsubstituted linear chain or branched chain alkenyl group, C₅-C₁₂ substituted or unsubstituted alicyclic group and C₆-C₂₀ substituted or unsubstituted aryl group; R₅ is C₆-C₂₀ substituted or unsubstituted aryloxy group; and at least one of R₃, R₄ and R₅ is an unsaturated group, the process comprises the following steps of:

(1) mixing in an anhydrous solvent a dichlorosilane monomer having the structure of Formula (II) with a polyphenylene ether resin having the structure of Formula (III), heating to a first temperature for a first reaction;
(2) adding a monofunctional phenolic monomer H—R₅ into the reaction system, heating to a second temperature to continue a second reaction to obtain the polyphenylene ether resin having the structure of Formula (I)

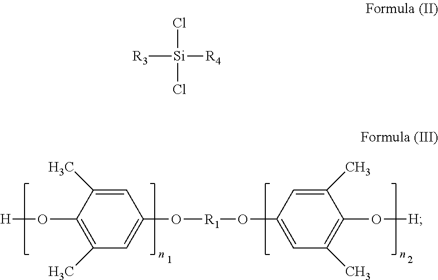

wherein R₁ and n have the same meanings as claim 1 or 2; or,
when R₃, R₄ and R₅ are each independently selected from the group consisting of C₁-C₈ substituted or unsubstituted linear chain or branched chain alkyl group, C₂-C₈ substituted or unsubstituted linear chain or branched chain alkenyl group, C₅-C₁₂ substituted or unsubstituted alicyclic group and C₆-C₂₀ substituted or unsubstituted aryl group, and at least one of R₃, R₄ and R₅ is an unsaturated group, the process comprises the following step of:
(a) mixing in an anhydrous solvent a monochlorosilane monomer having the structure of Formula (IV) with a polyphenylene ether resin having the structure of Formula (III), heating to a third temperature for a third reaction to obtain the polyphenylene ether resin having the structure of Formula (I)

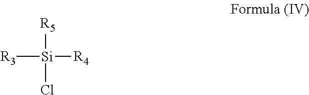

wherein R₁ and n have the same meanings as claim 1 or 2;
preferably, when R₃ and R₄ are each independently selected from the group consisting of

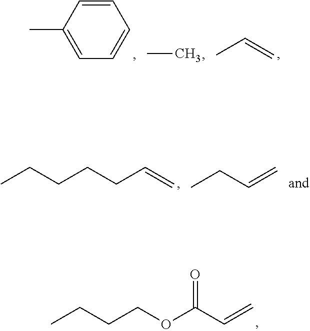

### and R₅ is

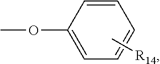

the process comprises the following steps of:
(1) mixing in an anhydrous solvent a dichlorosilane monomer having the structure of Formula (II) with a polyphenylene ether resin having the structure of Formula (III), heating to a first temperature for a first reaction;
(2) adding a monofunctional phenolic monomer H—R₅ into the reaction system, heating to a second temperature to continue a second reaction to obtain the polyphenylene ether resin having the structure of Formula (I)

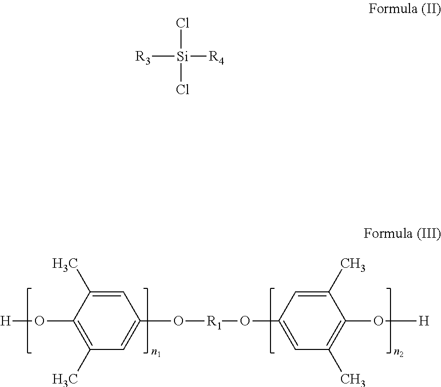

wherein R₁, R₁₄ and n have the same meanings as claim 1 or 2; or,
when R₃, R₄ and R₅ are each independently selected from the group consisting of

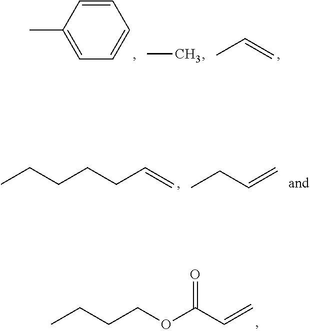

and at least one of R₃, R₄ and R₅ is an unsaturated group, the process comprises the following step of:
(a) mixing in an anhydrous solvent a monochlorosilane monomer having the structure of Formula (IV) with a polyphenylene ether resin having the structure of Formula (III), heating to a third temperature for a third reaction to obtain the polyphenylene ether resin having the structure of Formula (I)

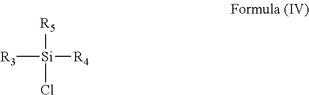

wherein R₁ and n have the same meanings as claim 1 or 2;
preferably, the anhydrous solvent is any one selected from the group consisting of tetrahydrofuran, dichloromethane, acetone, butanone, and a mixture of at least two selected therefrom; the mixture is selected from the group consisting of the mixture of tetrahydrofuran and dichloromethane, the mixture of acetone and butanone, the mixture of tetrahydrofuran and butanone, and the mixture of acetone, tetrahydrofuran and butanone.

Preferably, the first temperature and second temperature are each independently in the range of 0-60° C.; the first reaction time and second reaction time are each independently in the range of 2-24 h, further preferably 3-22 h, specifically preferably 4-20 h.

Preferably, the third temperature is in the range of 0-60° C., e.g. 2° C., 5° C., 10° C., 15° C., 20° C., 25° C., 30° C., 35° C., 40° C., 45° C., 50° C., 55° C., 58° C. and the like; the third reaction time is preferably in the range of 2-24 h, e.g. 2 h, 3 h, 5 h, 6 h, 7 h, 9 h, 11 h, 13 h, 15 h, 16 h, 17 h, 19 h, 20 h, 22 h, 24 h and the like, further preferably 3-22 h, specifically preferably 4-20 h.

The present invention provides a resin composition, and the resin composition comprises the silicone-modified polyphenylene ether resin.

The resin composition further comprises other resin having double bonds than the silicone-modified polyphenylene ether resin having the structure of Formula (I), and an initiator. The reaction is a radical reaction. The silicone-modified polyphenylene ether resin in the resin composition is added in an amount of preferably 10-90 parts by weight; the other resin having double bonds is added in an amount of preferably 10-90 parts by weight; the initiator can be added by those skilled in the art according to the actual needs.

Said “other resin having double bonds than the silicone-modified polyphenylene ether resin having the structure of Formula (I)” in the present invention is preferably polyolefin resin or silicone resin.

Preferably, the polyolefin resin is any one selected from the group consisting of styrene-butadiene copolymer, polybutadiene, styrene-butadiene-divinylbenzene copolymer, and a mixture of at least two selected therefrom. Said styrene-butadiene copolymer, polybutadiene, styrene-butadiene-divinylbenzene copolymer can be each independently modified by amino group, maleic anhydride, epoxy group, acrylate, hydroxyl group or carboxyl group.

Said “other resin having double bonds than the silicone-modified polyphenylene ether resin having the structure of Formula (I)” in the present invention are illustratively selected from the group consisting of styrene-butadiene copolymer R100 from Sartomer, polybutadiene B-1000 from Nippon Soda and styrene-butadiene-divinylbenzene copolymer R250 from Sartomer.

As one embodiment of the present invention, the silicone resin is any one selected from the silicone compounds containing unsaturated double bonds:

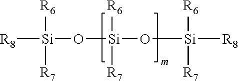

R₆, R₇ and R₈ are all independently selected from the group consisting of substituted or unsubstituted C₁-C₈ linear chain alkyl group, substituted or unsubstituted C₁-C₈ branched chain alkyl group, substituted or unsubstituted phenyl and substituted or unsubstituted C₂-C₁₀ C═C-containing group, and at least one of R₆, R₇ and R₈ is substituted or unsubstituted C₂-C₁₀ C═C-containing group, 0≤m≤100.

As another embodiment of the present invention, the silicone resin is any one selected from the silicone compounds containing unsaturated double bonds:

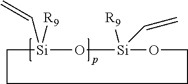

R₉ is selected from the group consisting of substituted or unsubstituted C₁-C₁₂ linear chain alkyl group, and substituted or unsubstituted C₁-C₁₂ branched chain alkyl group; 2≤p≤10, and p is a natural number.

The initiator is a radical initiator selected from organic peroxide initiators.

Preferably, the organic peroxide initiators of the present invention are any one selected from the group consisting of di-tert-butyl peroxide, dilauroyl peroxide, dibenzoyl peroxide, cumyl peroxyneodecanoate, tert-butyl peroxyneodecanoate, tert-amyl peroxypivalate, tert-butyl peroxypivalate, tert-butyl peroxyisobutyrate, tert-butyl-peroxy-3,5,5-trimethylhexanoate, tert-butyl peroxyacetate, tert-butyl peroxybenzoate, 1,1-di-tert-butyl peroxy-3,5,5-trimethylcyclohexane, 1,1-di-tert-butylperoxycyclohexane, 2,2-di(tert-butyl-peroxy)butane, bis(4-tert-butylcyclohexyl)peroxydicarbonate, hexadecyl peroxydicarbonate, tetradecyl peroxydicarbonate, ditetohexan peroxide, diisopropylbenzene peroxide, bis(tert-butyl-peroxyisopropyl)benzene, 2,5-dimethyl-2,5-di-tert-butylperoxyhexane, 2,5-dimethyl-2,5-bis-tert-butyl hexyne peroxide, dicumyl hydroperoxide, cumene hydroperoxide, t-amyl hydroperoxide, tert-butyl hydroperoxide, t-butyl peroxycumene, dicumyl hydroperoxide, tert-butyl-peroxy-carbonate-2-ethylhexanoate, tert-butyl-2-ethylhexyl-peroxydicarbonate, n-butyl-4,4-di(t-butylperoxy)valerate, methyl ethyl ketone peroxide, cyclohexane peroxide, and a mixture of at least two selected therefrom.

The resin composition may further comprise silicon-hydrogen resin and hydrosilylation catalyst. The reaction is a hydrosilylation reaction. The amount of the silicone-modified polyphenylene ether resin and the amount of the silicon-hydrogen resin added in the resin composition are calculated according to the equivalents of the silicon-hydrogen bonds and the double bonds, and the hydrosilylation catalyst may be added by those skilled in the art according to actual needs.

As one specific embodiment of the present invention, the silicon-hydrogen resin of the present invention is any one selected from the group consisting of the silicone compounds containing silicon-hydrogen bonds:

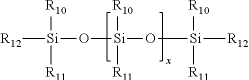

wherein R₁₀, R₁₁ [symbol] R₁₂ are all independently selected from the group consisting of substituted or unsubstituted C₁-C₈ linear chain alkyl group, substituted or unsubstituted C₁-C₈ branched chain alkyl group, substituted or unsubstituted phenyl and H atom, and at least one of R₁₀, R₁₁ and R₁₂ is H atom; 0≤x≤100.

As another specific embodiment of the present invention, the silicon-hydrogen resin of the present invention is any one selected from the group consisting of the silicone compounds containing silicon-hydrogen bonds:

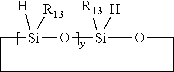

wherein R₁₃ is selected from the group consisting of substituted or unsubstituted C₁-C₁₂ linear chain alkyl group and substituted or unsubstituted C₁-C₁₂ branched chain alkyl group; 2≤y≤10, and y is a natural number.

The hydrosilylation catalyst of the present invention is a platinum catalyst.

Preferably, the resin composition may further comprise an inorganic filler or/and a flame retardant and can be added by those skilled in the art according to the actual needs.

The inorganic filler of the present invention is any one selected from the group consisting of aluminum hydroxide, boehmite, silica, talc powder, mica, barium sulfate, lithopone, calcium carbonate, wollastonite, kaolin, brucite, diatomaceous earth, bentonite, pumice powder, and a mixture of at least two selected therefrom.

The flame retardant of the present invention is any one selected from the group consisting of halogenated flame retardants, phosphorus flame retardants, inorganic flame retardants, and a combination of at least two selected therefrom. The flame retardant is tris(2,6-dimethylphenyl)phosphine, 10-(2,5-dihydroxyphenyl)-9,10-dihydro-9-oxa-10-phosphaphenanthrene-10-oxide, 2,6-bis(2,6-dimethylphenyl)phosphinobenzene, 10-phenyl-9,10-dihydro-9-oxa-10-phosphaphenanthrene-10-oxide, phenoxyphosphazene compound, zinc borate, nitrogen-phosphorus intumescent flame retardant, organic polymer flame retardant, phosphorus-containing phenolic resin, phosphorus-containing bismaleimide, and a mixture of at least two selected therefrom.

As one method for preparing the resin composition comprising the silicone-modified polyphenylene ether of the present invention, the modified polyphenylene ether resin, other resin with double bonds, silicon-hydrogen resin, initiator, hydrosilylation catalyst, filler and the like may be blended, stirred, and mixed by known methods to obtain the resin composition.

The present invention provides a resin varnish obtained by dissolving or dispersing the resin composition in a solvent.

Illustratively, the solvent can be exemplified by ethyl cellosolve, butyl cellosolve, ethylene glycol monomethyl ether, carbitol, butyl carbitol and other ethers, acetone, butanone, methyl ethyl ketone, methyl isobutyl ketone, cyclohexanone and other ketones, toluene, xylene, mesitylene and other aromatic hydrocarbons, ethoxyethyl acetate, ethyl acetate and other esters, N,N-dimethylformamide, N,N-dimethylacetamide, N-methyl-2-pyrrolidone and other nitrogen-containing solvents. The solvents may be used separately or in combination of two or more. Preferably, aromatic hydrocarbon solvents such as toluene and xylene, and ketone solvents such as acetone, butanone, methyl ethyl ketone, methyl isobutyl ketone and cyclohexanone are mixed and used. The amount of the solvent can be selected by those skilled in the art according to their own experience, so that the obtained resin varnish can reach a viscosity suitable for use.

In the process of dissolving or dispersing the resin composition in a solvent, an emulsifier may be added for even dispersion of the inorganic filler in the varnish.

The present invention provides a cured resin obtained by curing the resin composition.

The present invention provides a prepreg comprising a reinforcing material and the resin composition attached thereto by impregnation and drying.

The reinforcing material may illustratively be carbon fiber, glass fiber cloth, aramid fiber or non-woven fabric.

Examples of the carbon fibers include T300, T700, and T800 manufactured by Toray Industries of Japan. Examples of the aramid fibers include, e.g. Kevlar fibers. Examples of the glass fiber cloth include 7628 fiberglass cloth and 2116 glass fiber cloth.

The present invention provides a copper clad laminate comprising at least one prepreg.

The present invention provides a laminate comprising at least one prepreg.

The present invention provides a printed circuit board comprising at least one prepreg.

As compared with the prior art, the present invention has the following beneficial elects,

(1) The present invention incorporates C═C double bonds and siloxy groups into the terminal group of polyphenylene ether, and combines the low dielectric properties of double bond curing with the heat resistance, weather resistance, flame retardancy and low water absorption rate of the siloxy groups, which plays a greater application role of polyphenylene ether resin in copper clad laminates, and can provide excellent dielectric properties, heat and moisture resistance, heat resistance required for high-frequency high-speed copper clad laminates.

(2) The process for preparing the silicone-modified polyphenylene ether resin provided by the present invention is simple and convenient, easy to purify.

### DESCRIPTION OF THE DRAWINGS

FIG. 1 is a NMR spectrum of the modified resin d provided in Preparation Example 4.

### EMBODIMENTS

The technical solutions of the present invention will be further described below through specific embodiments.

Those skilled in the art shall know that the described examples are used only for understanding of the present invention and should not be construed as particularly limiting the present invention.

### Preparation Example 1

74 parts by weight of polyphenylene ether resin MX90 and 1000 mL of anhydrous tetrahydrofuran were stirred in a reactor equipped with a stirrer, a dropping funnel, a thermometer and a gas pipe (nitrogen gas) until completely dissolved into a uniform solution. Continuous nitrogen gas was supplied for 0.5-1 h to remove the water vapor in the reactor. Nitrogen gas was maintained throughout the reaction. The temperature in the reactor was kept below 20° C., and then 17 parts by weight of diallyldichlorosilane was slowly added dropwise. After completion of the addition, the reactor was maintained at a temperature of 20° C. or lower for 5-10 hours, and then the temperature was raised to 40-60° C. for 10-22 hours. Subsequently, 9 parts by weight of phenol was added dropwise to the reactor and reacted at 40-60° C. for 10-22 hours. After completion of the reaction, tetrahydrofuran was removed by distillation under reduced pressure, to obtain a silicone-modified polyphenylene ether resin containing unsaturated double bonds (modified resin a).

### Preparation Example 2

77 parts by weight of polyphenylene ether resin MX90 and 1000 mL of anhydrous tetrahydrofuran were stirred in a reactor equipped with a stirrer, a dropping funnel, a thermometer and a gas pipe (nitrogen gas) until completely dissolved into a uniform solution. Continuous nitrogen gas was supplied for 0.5-1 h to remove the water vapor in the reactor. Nitrogen gas was maintained throughout the reaction. The temperature in the reactor was kept below 20° C., and then 14 parts by weight of methylvinyldichlorosilane was slowly added dropwise. After completion of the addition, the reactor was maintained at a temperature of 20° C. or lower for 5-10 hours, and then the temperature was raised to 40-60° C. for 10-22 hours.

Subsequently, 9 parts by weight of phenol was added dropwise to the reactor and reacted at 40-60° C. for 10-22 hours. After completion of the reaction, tetrahydrofuran was removed by distillation under reduced pressure, to obtain a silicone-modified polyphenylene ether resin containing unsaturated double bonds (modified resin b).

### Preparation Example 3

81 parts by weight of polyphenylene ether resin MX90 and 1000 mL of anhydrous tetrahydrofuran were stirred in a reactor equipped with a stirrer, a dropping funnel, a thermometer and a gas pipe (nitrogen gas) until completely dissolved into a uniform solution. Continuous nitrogen gas was supplied for 0.5-1 h to remove the water vapor in the reactor. Nitrogen gas was maintained throughout the reaction. The temperature in the reactor was kept below 20° C., and then 19 parts by weight of methylphenylvinylmonochlorosilane was slowly added dropwise. After completion of the addition, the reactor was maintained at a temperature of 20° C. or lower for 5-10 hours, and then the temperature was raised to 40-60° C. for 10-22 hours. After completion of the reaction, tetrahydrofuran was removed by distillation under reduced pressure, to obtain a silicone-modified polyphenylene ether resin containing unsaturated double bonds (modified resin c).

### Preparation Example 4

83 parts by weight of polyphenylene ether resin MX90 and 1000 mL of anhydrous tetrahydrofuran were stirred in a reactor equipped with a stirrer, a dropping funnel, a thermometer and a gas pipe (nitrogen gas) until completely dissolved into a uniform solution. Continuous nitrogen gas was supplied for 0.5-1 h to remove the water vapor in the reactor. Nitrogen gas was maintained throughout the reaction. The temperature in the reactor was kept below 20° C., and then 17 parts by weight of dimethylyinylmonochlorosilane was slowly added dropwise. After completion of the addition, the reactor was maintained at a temperature of 20° C. or lower for 5-10 hours, and then the temperature was raised to 40-60 ° C. for 10-22 hours. After completion of the reaction, tetrahydrofuran was removed by distillation under reduced pressure, to obtain a silicone-modified polyphenylene ether resin containing unsaturated double bonds (modified resin d).

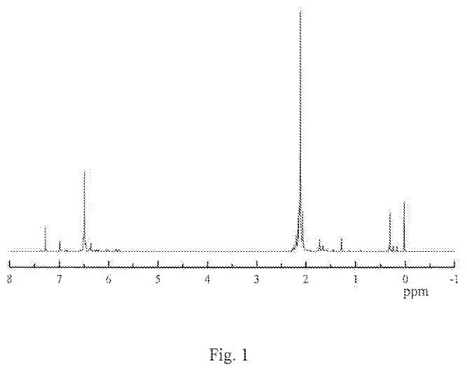

FIG. 1 shows the NMR spectrum of modified resin d: 1H NMR (DMSO-d6, ppm). NMR spectrum: 0.029 ppm is the chemical shift of methyl H atom on Si; 0.313 and 1.74 ppm are the chemical shift of methyl H atom on tertiary carbon; 2.117 ppm is the chemical shift of methyl H atom on phenyl ring; 5.80-6.24 ppm is the chemical shift of H atom on silicon vinyl group; and 6.49-7.29 ppm is the chemical shift of H atom on benzene ring.

### Application Example 1

78 parts by weight of the silicone-modified polyphenylene ether resin (modified resin a) prepared in Preparation Example 1 and 22 parts by weight of phenyl silicon hydrogen resin SH303 were dissolved in an appropriate amount of butanone solvent and adjusted to an appropriate viscosity. A total amount of 10 ppm platinum catalyst was added and stirred well. The gas was pumped under vacuum for a period of time to remove air bubbles and butanone in the varnish system. The processed varnish was poured into a mold and placed at 50° C. for 1 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resulted cured product, the dielectric constant and dielectric loss factor thereof were measured at 23° C. and 1 GHz by the plate capacitance method. The 5% weight reduction temperature (Td 5%) under a nitrogen atmosphere was evaluated using a TGA at a heating rate of 10° C./min. The DMA was used to test its glass transition temperature. The performance test results are shown in Table 1.

### Application Example 2

77 parts by weight of the silicone-modified polyphenylene ether resin (modified resin c) prepared in Preparation Example 3 and 23 parts by weight of phenyl silicon hydrogen resin SH303 were dissolved in an appropriate amount of butanone solvent and adjusted to an appropriate viscosity. A total amount of 10 ppm platinum catalyst was added and stirred well. The gas was pumped under vacuum for a period of time to remove air bubbles and butanone in the varnish system. The processed varnish was poured into a mold and placed at 50° C. for 1 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resulted cured product, the dielectric constant and dielectric loss factor thereof were measured at 23° C. and 1 GHz by the plate capacitance method. The 5% weight reduction temperature (Td 5%) under a nitrogen atmosphere was evaluated using a TGA at a heating rate of 10° C./min. The DMA was used to test its glass transition temperature. The performance test results are shown in Table 1.

### Application Example 3

99 parts by weight of the silicone-modified polyphenylene ether resin (modified resin b) prepared in Preparation Example 2 and 3 parts by weight of dicumyl peroxide were dissolved in an appropriate amount of butanone solvent, adjusted to an appropriate viscosity and homogeneously stirred. The gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resulted cured product, the dielectric constant and dielectric loss factor thereof were measured at 23° C. and 1 GHz by the plate capacitance method. The 5% weight reduction temperature (Td 5%) under a nitrogen atmosphere was evaluated using a TGA at a heating rate of 10° C./min. The DMA was used to test its glass transition temperature. The performance test results are shown in Table 1.

### Application Example 4

99 parts by weight of the silicone-modified polyphenylene ether resin (modified resin d) prepared in Preparation Example 4 and 3 parts by weight of dicumyl peroxide were dissolved in an appropriate amount of butanone solvent, adjusted to an appropriate viscosity and homogeneously stirred. The gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resulted cured product, the dielectric constant and dielectric loss factor thereof were measured at 23° C. and 1 GHz by the plate capacitance method. The 5% weight reduction temperature (Td 5%) under a nitrogen atmosphere was evaluated using a TGA at a heating rate of 10° C./min. The DMA was used to test its glass transition temperature. The performance test results are shown in Table 1.

### Application Example 5

77 parts by weight of the silicone-modified polyphenylene ether resin (modified resin d) prepared in Preparation Example 4, 20 parts by weight of butylbenzene copolymer Ricon100 and 3 parts by weight of dicumyl peroxide were dissolved in an appropriate amount of butanone solvent, adjusted to an appropriate viscosity and homogeneously stirred. The gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resulted cured product, the dielectric constant and dielectric loss factor thereof were measured at 23° C. and 1 GHz by the plate capacitance method. The 5% weight reduction temperature (Td 5%) under a nitrogen atmosphere was evaluated using a TGA at a heating rate of 10° C./min. The DMA was used to test its glass transition temperature. The performance test results are shown in Table 1.

### Application Comparison Example 1

10 ppm of a platinum catalyst was added to 61 parts by weight of vinylphenyl silicon resin and 39 parts by weight of phenyl silicon hydrogen resin, and homogeneously stirred. The gas was pumped under vacuum for a period of time to remove air bubbles and butanone in the varnish system. The processed varnish was poured into a mold and placed at 50° C. for 5 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resulted cured product, the dielectric constant and dielectric loss factor thereof were measured at 23° C. and 1 GHz by the plate capacitance method. The 5% weight reduction temperature (Td 5%) under a nitrogen atmosphere was evaluated using a TGA at a heating rate of 10° C./min. The DMA was used to test its glass transition temperature. The performance test results are shown in Table 1.

### Application Comparison Example 2

97 parts by weight of methacrylate polyphenylene ether resin MX9000 and 3 parts by weight of dicumyl peroxide (DCP) were dissolved in an appropriate amount of butanone solvent, adjusted to an appropriate viscosity and homogeneously stirred. The gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resulted cured product, the dielectric constant and dielectric loss factor thereof were measured at 23° C. and 1 GHz by the plate capacitance method. The 5% weight reduction temperature (Td 5%) under a nitrogen atmosphere was evaluated using a TGA at a heating rate of 10° C./min. The DMA was used to test its glass transition temperature. The performance test results are shown in Table 1.

### Application Comparison Example 3

77 parts by weight of methacrylate polyphenylene ether resin MX9000, 20 parts by weight of butylbenzene copolymer Ricon100 and 3 parts by weight of dicumyl peroxide were dissolved in an appropriate amount of butanone solvent, adjusted to an appropriate viscosity and homogeneously stirred. The gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resulted cured product, the dielectric constant and dielectric loss factor thereof were measured at 23° C. and 1 GHz by the plate capacitance method. The 5% weight reduction temperature (Td 5%) under a nitrogen atmosphere was evaluated using a TGA at a heating rate of 10° C./min. The DMA was used to test its glass transition temperature. The performance test results are shown in Table 1.

Specific materials in the examples and comparison examples are listed as follows.

Phenolic formaldehyde linear novolac resin: 2812, Momentive, Korea.
Dicyclopentadiene-type novolac resin: 9110, Changchun, Taiwan.
Biphenyl-type novolac resin: 7851-H, Meiwa, Japan.
Methacrylate polyphenylene ether resin: MX9000, Sabic.
Butylbenzene copolymer: Ricon100, Satomer.
Dicumyl peroxide: Shanghai Gaoqiao.
Phenyl silicon hydrogen resin: SH303, Runhe Chemical.
Vinylphenyl silicon Resin: SP606, Runhe Chemical.

The measuring criteria or methods for the parameters in Table 1 are as follows:

(1) Glass transition temperature (Tg): tested by using DMA and determined according to the DMA test method specified in IPC-TM-650 2.4.24.4;
(2) Dielectric constant and dielectric loss factor: tested in accordance with IPC-TM-650 2.5.5.9 with the test frequency of 1 GHz;
(3) Thermal Decomposition Temperature (Td5%): Determined by the TGA method specified in IPC-TM-650 2.4.24 according to thermogravimetric analysis (TGA).

TABLE 1
Performance test results of the copper clad laminates provided
by the application examples

| | Application Examples | | | | |
|---|---|---|---|---|---|
| Performances | 1 | 2 | 3 | 4 | 5 |
| Dielectric | 2.38 | 2.36 | 2.39 | 2.41 | 2.43 |
| constant | | | | | |
| (1 GHz) | | | | | |
| Dielectric | 0.0038 | 0.0035 | 0.0040 | 0.0033 | 0.0039 |
| loss (1 GHz) | | | | | |
| Tg (° C.) | 217.8 | 215.2 | 208.5 | 205.3 | 201.1 |
| Td (5%) | 463.6 | 470.3 | 433.7 | 427.9 | 420.4 |

TABLE 2
Performance test results of the copper clad laminates provided
by the application comparison examples

| | Application | | |
|---|---|---|---|
| | Comparison Examples | | |
| Performances | 1 | 2 | 3 |
| Dielectric constant (1 GHz) | 2.76 | 2.93 | 3.06 |
| Dielectric loss (1 GHz) | 0.0063 | 0.0105 | 0.0078 |
| Tg (° C.) | 157.7 | 212.7 | 198.6 |
| Td (5%) | 589.9 | 375.0 | 398.5 |

Application Examples 1 and 2 show that, as compared to general vinyl phenyl silicone resins (Application Comparison Example 1), the cured product of the resin composition containing the silicone-modified polyphenylene ether resin with unsaturated double bonds synthesized according to the present invention has more excellent dielectric properties and a higher glass transition temperature. Application Examples 3-5 show that, as compared to methylacrylate polyphenylene ether resin (Application Comparison Examples 2 and 3), the cured product of the resin composition containing the silicone-modified polyphenylene ether resin with unsaturated double bonds synthesized according to the present invention also has more excellent dielectric properties, a higher glass transition temperature, and a higher thermal decomposition temperature. Therefore, the silicone-modified polyphenylene ether resin containing unsaturated double bonds is a resin with more excellent comprehensive performance, can be used for the preparation of high-frequency circuit substrates, and has great application value.

It should be noted and understood that various modifications and amendments can be made to the above-described detailed invention without departing from the spirit and scope of the present invention as claimed in the appended claims. Thus, the scope of the claimed technical solution is not limited by any of the specific exemplary teachings given.

The applicant claims that the present invention describes the detailed process of the present invention, but the present invention is not limited to the detailed process of the present invention. That is to say, it does not mean that the present invention shall be carried out with respect to the above-described detailed process of the present invention. Those skilled in the art shall know that any improvements to the present invention, equivalent replacements of the raw materials of the present invention, additions of auxiliary, selections of any specific ways all fall within the protection scope and disclosure scope of the present invention.

1-13. (canceled)

14. A silicone-modified polyphenylene ether resin, wherein the polyphenylene ether resin has a structure of Formula (I) 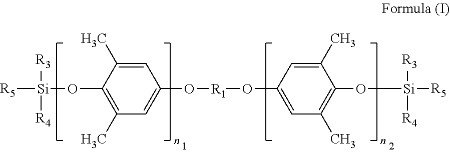
wherein R₁ is selected from the group consisting of 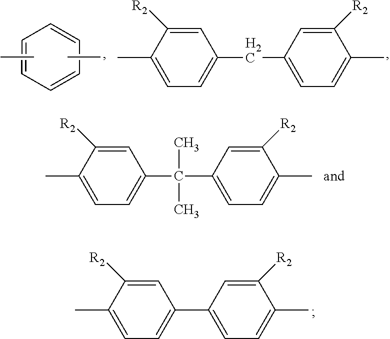
R₂ is selected from the group consisting of H, allyl group and isoallyl group;
R₃, R₄ and R₅ are each independently selected from the group consisting of C₁-C₈ substituted or unsubstituted linear chain or branched chain alkyl group, C₂-C₈ substituted or unsubstituted linear chain or branched chain alkenyl group, C₅-C₁₂ substituted or unsubstituted alicyclic group, C₆-C₂₀ substituted or unsubstituted aryl group and C₆-C₂₀ substituted or unsubstituted aryloxy group; and at least one of R₃, R₄ and R₅ is an unsaturated group; and
n₁ and n₂ are each independently positive integers, and satisfy 4≤n₁+n₂≤25.

15. The polyphenylene ether resin as claimed in claim 14, wherein R₃, R₄ and R₅ are each independently selected from the group consisting of 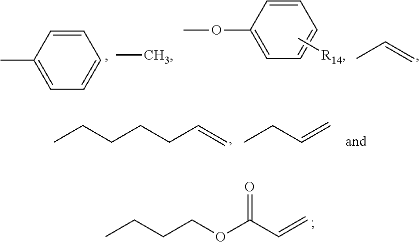
R₁₄ is selected from the group consisting of H, C₁-C₁₄ substituted or unsubstituted linear chain or branched chain alkyl group, C₅-C₁₂ substituted or unsubstituted alicyclic group and C₁-C₁₄ alkoxy group.

16. The polyphenylene ether resin as claimed in claim 14, wherein the polyphenylene ether resin is selected from the group consisting of 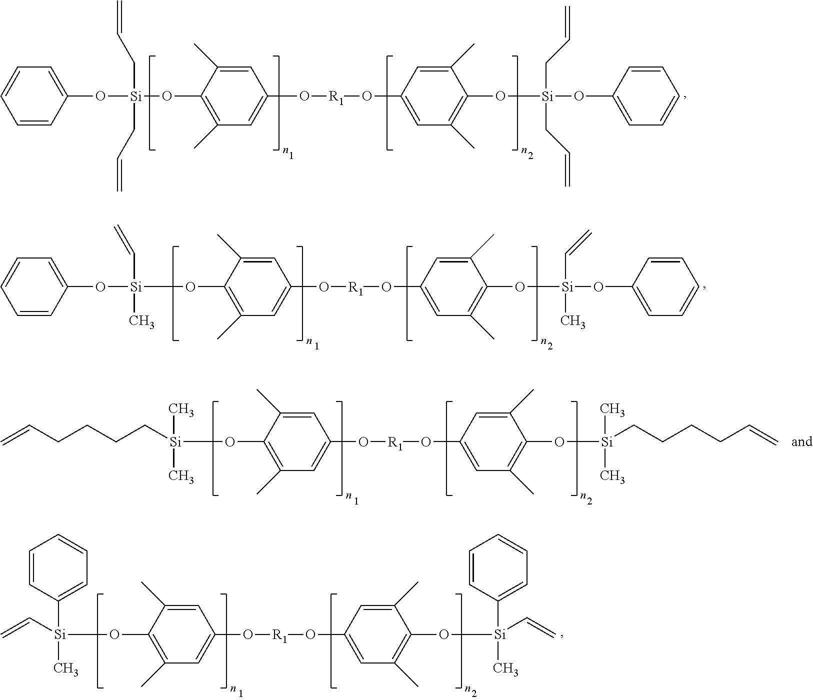
wherein each of n₁ and n₂ is independently a positive integer; 4≤n₁+n₂≤25.

17. A process for preparing the polyphenylene ether resin as claimed in claim 14, wherein when R₃ and R₄ are each independently selected from the group consisting of C₁-C₈ substituted or unsubstituted linear chain or branched chain alkyl group, C₂-C₈ substituted or unsubstituted linear chain or branched chain alkenyl group, C₅-C₁₂ substituted or unsubstituted alicyclic group and C₆-C₂₀ substituted or unsubstituted aryl group; R₅ is C₆-C₂₀ substituted or unsubstituted aryloxy group; and at least one of R₃, R₄ and R₅ is an unsaturated group, the process comprises the following steps of:
(1) mixing in an anhydrous solvent a dichlorosilane monomer having the structure of Formula (II) with a polyphenylene ether resin having the structure of Formula (III), heating to a first temperature for a first reaction;
(2) adding a monofunctional phenolic monomer H—R₅ into the reaction system, heating to a second temperature to continue a second reaction to obtain the polyphenylene ether resin having the structure of Formula (I) 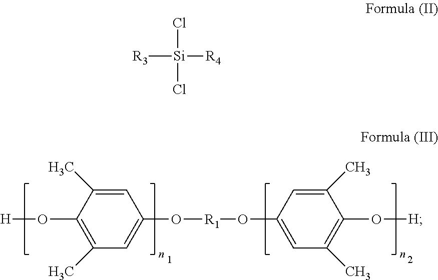
or
when R₃, R₄ and R₅ are each independently selected from the group consisting of C₁-C₈ substituted or unsubstituted linear chain or branched chain alkyl group, C₂-C₈ substituted or unsubstituted linear chain or branched chain alkenyl group, C₅-C₁₂ substituted or unsubstituted alicyclic group and C₆-C₂₀ substituted or unsubstituted aryl group, and at least one of R₃, R₄ and R₅ is an unsaturated group, the process comprises the following step of:
(a) mixing in an anhydrous solvent a monochlorosilane monomer having the structure of Formula (IV) with a polyphenylene ether resin having the structure of Formula (III), heating to a third temperature for a third reaction to obtain the polyphenylene ether resin having the structure of Formula (I)

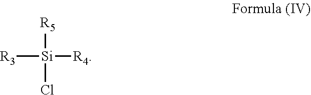

18. The process as claimed in claim 17, wherein when R₃ and R₄ are each independently selected from the group consisting of 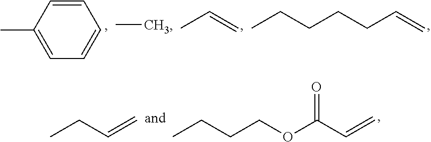
and R₅ is 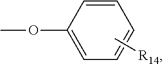
the process comprises the steps of:
(1) mixing in an anhydrous solvent a dichlorosilane monomer having the structure of Formula (II) with a polyphenylene ether resin having the structure of Formula (III), heating to a first temperature for a first reaction;
(2) adding a monofunctional phenolic monomer H—R₅ into the reaction system, heating to a second temperature to continue a second reaction to obtain the polyphenylene ether resin having the structure of Formula (I) 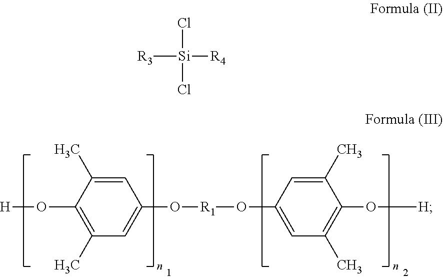
or
when R₃, R₄ and R₅ are each independently selected from the group consisting of 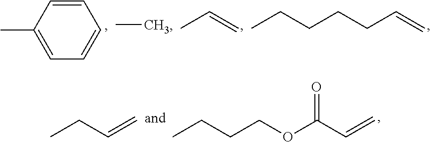
and at least one of R₃, R₄ and R₅ is an unsaturated group, the process comprises the following step of:
(a) mixing in an anhydrous solvent a monochlorosilane monomer having the structure of Formula (IV) with a polyphenylene ether resin having the structure of Formula (III), heating to a third temperature for a third reaction to obtain the polyphenylene ether resin having the structure of Formula (I)

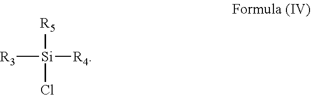

19. The process as claimed in claim 17, wherein the anhydrous solvent is any one selected from the group consisting of tetrahydrofuran, dichloromethane, acetone, butanone, and a mixture of at least two selected therefrom.

20. The process as claimed in claim 17, wherein the first temperature and second temperature are each independently in the range of 0-60° C.; the first reaction time and second reaction time are each independently in the range of 2-24 h.

21. The process as claimed in claim 17, wherein the third temperature is in the range of 0-60° C.; the third reaction time is in the range of 2-24 h.

22. A resin composition comprising the silicone-modified polyphenylene ether resin of claim 14.

23. The resin composition as claimed in claim 22, wherein the resin composition further comprises other resin having double bonds than the silicone-modified polyphenylene ether resin having the structure of Formula (I), and an initiator.

24. The resin composition as claimed in claim 23, wherein the other resin having double bonds is polyolefin resin or silicone resin.

25. The resin composition as claimed in claim 24, wherein the polyolefin resin is any one selected from the group consisting of styrene-butadiene copolymer, polybutadiene, styrene-butadiene-divinylbenzene copolymer, and a mixture of at least two selected therefrom.

26. The resin composition as claimed in claim 25, wherein the styrene-butadiene copolymer, polybutadiene, styrene-butadiene-divinylbenzene copolymer can be each independently modified by amino group, maleic anhydride, epoxy group, acrylate, hydroxyl group or carboxyl group.

27. The resin composition as claimed in claim 24, wherein the silicone resin is any one selected from the silicone compounds containing unsaturated double bonds: 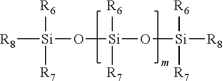
R₆, R₇ and R₈ are all independently selected from the group consisting of substituted or unsubstituted C₁-C₈ linear chain alkyl group, substituted or unsubstituted C₁-C₈ branched chain alkyl group, substituted or unsubstituted phenyl and substituted or unsubstituted C₂-C₁₀ C═C -containing group, and at least one of R₆, R₇ and R₈ is substituted or unsubstituted C₂-C₁₀ C═C -containing group, 0≤m≤100; or, 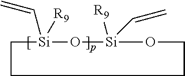
R₉ is selected from the group consisting of substituted or unsubstituted C₁-C₁₂ linear chain alkyl group, and substituted or unsubstituted C₁-C₁₂ branched chain alkyl group; 2≤p≤10, and p is a natural number.

28. The resin composition as claimed in claim 22, wherein the resin composition further comprises silicon-hydrogen resin and hydrosilylation catalyst.

29. The resin composition as claimed in claim 28, wherein the silicon-hydrogen resin is any one selected from the group consisting of the silicone compounds containing silicon-hydrogen bonds: 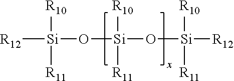
wherein R₁₀, R₁₁ [symbol] R₁₂ are all independently selected from the group consisting of substituted or unsubstituted C₁-C₈ linear chain alkyl group, substituted or unsubstituted C₁-C₈ branched chain alkyl group, substituted or unsubstituted phenyl and H atom, and at least one of R₁₀, R₁₁ and R₁₂ is H atom; 0≤x≤100; or, 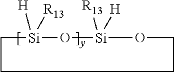
R₁₃ is selected from the group consisting of substituted or unsubstituted C₁-C₁₂ linear chain alkyl group and substituted or unsubstituted C₁-C₁₂ branched chain alkyl group; 2≤y≤10, and y is a natural number.

30. The resin composition as claimed in claim 22, further comprising an inorganic filler;

31. The resin composition as claimed in claim 22, further comprising a flame retardant.

32. A prepreg comprising a reinforcing material and the resin composition as claimed in claim 22 attached thereto by impregnation and drying.

33. A printed circuit board, comprising the prepreg as claimed in claim 32.
